(19) United States
(12) Patent Application Publication
(10) Pub. No.: US 2023/0069690 A1
(43) Pub. Date: Mar. 2, 2023

(54) TERMINAL, RADIO COMMUNICATION METHOD, AND BASE STATION

(71) Applicant: NTT DOCOMO, INC., Tokyo (JP)

(72) Inventors: Yuki Takahashi, Chiyoda-ku, Tokyo (JP); Satoshi Nagata, Chiyoda-ku, Tokyo (JP); Lihui Wang, Beijing, Haidian District (CN); Xiaolin Hou, Beijing, Haidian District (CN)

(73) Assignee: NTT DOCOMO, INC., Tokyo (JP)

(21) Appl. No.: 17/798,474

(22) PCT Filed: Feb. 10, 2020
(86) PCT No.: PCT/JP2020/005187

§ 371 Date: Aug. 9, 2022

(51) Int. Cl. H04L 1/18

(52) U.S. Cl. CPC H04L 1/1819

(57) ABSTRACT

A terminal according to one aspect of the present disclosure includes a receiving section that receives information regarding a repetition factor and information regarding a redundancy version sequence used for a repetition transmission, and a control section that determines, when the repetition factor is greater than eight, a transmission occasion at which initial transmission of a transport block can be started from a plurality of transmission occasions corresponding to the repetition factor based on at least one of the redundancy version sequence and the repetition factor.

### TECHNICAL FIELD

The present disclosure relates to a terminal, a radio communication method, and a base station in next-generation mobile communication systems.

### BACKGROUND ART

In the universal mobile telecommunications system (UMTS) network, the specifications of long term evolution (LTE) have been drafted for the purpose of further increasing data rates, providing low delays, and so on (Non Patent Literature 1). In addition, the specifications of LTE-Advanced (third generation partnership project (3GPP) Release (Rel.) 10 to 14) have been drafted for the purpose of further increasing capacity and advancement of LTE (3GPP Rel. 8 and 9).

Successor systems to LTE (for example, also referred to as 5th generation mobile communication system (5G), 5G+(plus), 6th generation mobile communication system (6G), New Radio (NR), or 3GPP Rel. 15 and subsequent releases) are also being studied.

In the existing LTE system (for example, 3GPP Rel. 8 to 15), a user terminal (user equipment (UE)) controls reception of a downlink shared channel (for example, a physical downlink shared channel (PDSCH)) based on downlink control information (DCI, also referred to as DL assignment or the like) from a base station. Also, the user terminal controls transmission of an uplink shared channel (for example, a physical uplink shared channel (PUSCH)) based on DCI (also referred to as UL grant or the like).

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In a future radio communication system (for example, NR), configured grant-based transmission for UL transmission will be supported. Furthermore, it is also assumed that repetition transmission is supported in the configured grant-based transmission.

For example, in a case where the repetition transmission is used in the configured grant-based, it is conceivable that the UE controls the timing of the repetition transmission in consideration of at least one of the number of repetitions (also referred to as a repetition factor) and the redundancy version sequence. On the other hand, in a future radio communications system (for example, Rel. 16 and subsequent releases), it is also assumed that a repetition factor supported by the UE is extended.

However, in a case where the repetition factor is extended, how to control the repetition transmission (for example, start timing of repetition transmission, and the like) has not been sufficiently studied yet.

Therefore, an object of the present disclosure is to provide a terminal, a radio communication method, and a base station capable of appropriately performing repetition transmission even in a case where the repetition factor is extended.

### Solution to Problem

A terminal according to one aspect of the present disclosure includes a receiving section that receives information regarding a repetition factor and information regarding a redundancy version sequence used for a repetition transmission, and a control section that determines, when the repetition factor is greater than eight, a transmission occasion at which initial transmission of a transport block can be started from a plurality of transmission occasions corresponding to the repetition factor based on at least one of the redundancy version sequence and the repetition factor.

### Advantageous Effects of Invention

According to an aspect of the present disclosure, repetition transmission can be appropriately performed even when a repetition factor is extended.

### BRIEF DESCRIPTION OF DRAWINGS

FIGS. 1A and 1B are diagrams illustrating an example of a repetition transmission.

FIG. 2 is a diagram illustrating an example of a relationship between an RV sequence and a transmission occasion in which start of initial transmission is allowed.

FIGS. 3A and 3B are diagrams illustrating an example of a repetition transmission control according to a first aspect.

FIGS. 4A and 4B are diagrams illustrating an example of a repetition transmission control according to a second aspect.

FIGS. 5A and 5B are diagrams illustrating another example of a repetition transmission control according to the second aspect.

FIGS. 6A and 6B are diagrams illustrating an example of a repetition transmission control according to a third aspect.

FIG. 7 is a diagram illustrating an example of a schematic configuration of a radio communication system according to one embodiment.

FIG. 8 is a diagram illustrating an example of a configuration of a base station according to one embodiment.

FIG. 9 is a diagram illustrating an example of a configuration of a user terminal according to one embodiment.

FIG. 10 is a diagram illustrating an example of a hardware configuration of a base station and a user terminal according to one embodiment.

### DESCRIPTION OF EMBODIMENTS

(Repetition Transmission)

In Rel. 15, repetition transmission is supported in data transmission. A base station (for example, network (NW), gNB) repeatedly transmits DL data (for example, downlink shared channel (PDSCH)) for a given number of times. Alternatively, a UE repeatedly transmits UL data (for example, uplink shared channel (PUSCH)) for a given number of times.

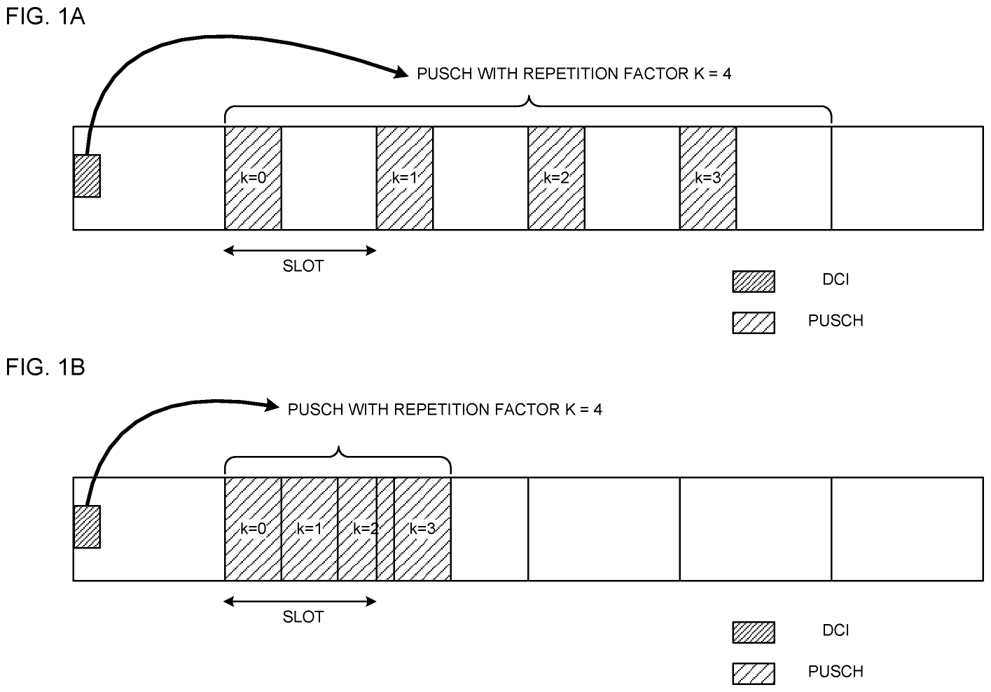

FIG. 1A is a diagram illustrating an example of repetition transmission of a PUSCH. FIG. 1A illustrates an example in which a given number of PUSCH repetitions are scheduled by a single piece of DCI. The number of repetitions is also referred to as a repetition factor K or an aggregation factor K.

In FIG. 1A, the repetition coefficient (hereinafter, also referred to as a repetition factor) K=4, however, the value of K is not limited thereto. In Rel. 15, repetition factors up to K=8 are supported. Further, an n-th repetition is also called an n-th transmission occasion, and the like, and may be identified by a repetition index k (0≤k≤K−1). In addition, FIG. 1A illustrates repetition transmission of a PUSCH dynamically scheduled by the DCI (for example, dynamic grant-based PUSCH), which may be applied to repetition transmission of a configured grant-based PUSCH.

For example, in FIG. 1A, the UE receives information indicating the repetition factor K (for example, aggregationFactorUL or aggregationFactorDL) by higher layer signaling. Here, the higher layer signaling may be, for example, any of radio resource control (RRC) signaling, medium access control (MAC) signaling, broadcast information, and so on, or a combination thereof.

For the MAC signaling, for example, a MAC control element (MAC CE), a MAC protocol data unit (PDU), or the like may be used. The broadcast information may be, for example, a master information block (MIB), a system information block (SIB), remaining minimum system information (RMSI), or the like.

The UE controls a PDSCH receiving process (for example, at least one of receiving, demapping, demodulation, or decoding) or a PUSCH transmitting process (for example, at least one of transmitting, mapping, modulation, or coding) in the K consecutive slots on the basis of DCI or information notified by higher layer signaling:
the allocation of time-domain resource (such as the start symbol and the number of symbols in each slot, for example),
the allocation of frequency-domain resource (for example, a given number of resource blocks (RB) or a given number of resource block groups (RBGs)),
the modulation and coding scheme (MCS) index,
the configuration of the demodulation reference signal (DMRS) of PDSCH, or
the state (TCI-state) of the transmission configuration indication or transmission configuration indicator (TCI).

The same symbol allocation may be applied between consecutive K slots. FIG. 1A illustrates a case where the PUSCH in each slot is allocated to a given number of symbols from the head of the slot. The same symbol allocation between slots may be determined as described in the above time domain resource allocation.

For example, the UE may determine the symbol allocation in each slot based on the start symbol S and the number of symbols L determined based on the value m of a given field (for example, the TDRA field) in the DCI. Note that the UE may determine the first slot based on the K2 information determined based on the value m of a given field (for example, the TDRA field) of the DCI. For configured grant-basis, symbol allocation may be determined based on information of higher layer signaling.

On the other hand, the redundancy versions (RVs) applied to the TBs based on the same data may be the same or at least partially different between the consecutive K slots. For example, the RV applied to the TB in the n-th slot (transmission occasion, repetition) may be determined based on the value of a given field (for example, the RV field) in the DCI.

When a resource allocated in consecutive K slots is different in a communication direction in UL, DL, or flexible and one symbol in each slot indicated by at least one of uplink and downlink communication direction indication information for TDD control (for example, “TDD-UL-DL-ConfigCommon” and “TDD-UL-DL-ConfigDedicated” of RRC IE) and a slot format identifier of DCI (for example, DCI format 2_0), the resource of the slot including the symbol may not be transmitted (or not received).

In Rel. 15, repetition transmission of PUSCH is performed over a plurality of slots (in units of slots) as illustrated in FIG. 1A. However, in Rel. 16 and subsequent releases, it is also assumed that repetition transmission of PUSCH is performed in units shorter than slots (for example, in units of subslots, in units of mini slots, or in units of a given number of symbols) (see FIG. 1B).

For example, the UE performs a plurality of PUSCH transmission within one slot. When repetition transmission is performed in units of subslots, one of a plurality of repetition transmission may cross a slot boundary depending on the number of repetition transmission (for example, K) and the data allocation unit (data length of each repetition). In FIG. 1B, a PUSCH with k=2 is arranged across a slot boundary. In such a case, the PUSCH may be divided (or segmented) with respect to the slot boundary and transmitted.

In addition, a case is also assumed in which a symbol (for example, DL symbol or the like) that cannot be used for PUSCH transmission is included in the slot. In such a case, PUSCH transmission may be performed using a symbol excluding the DL symbol. In this case, the PUSCH may be divided (or segmented).

Subslot-based repetition transmission may be referred to as a repetition transmission type B (for example, PUSCH repetition Type B). By performing the repetition transmission of PUSCH on the subslot basis, it is possible to complete the repetition transmission of the PUSCH earlier as compared with a case where the repetition transmission is performed in units of slots.

<Configured Grant-Based Transmission (Type 1, Type 2)>

Dynamic grant-based transmission and configured grant-based transmission have been studied for UL transmission of NR.

Dynamic grant-based transmission is a method for performing UL transmission by using a Physical Uplink Shared Channel (PUSCH) on the basis of a dynamic UL grant (dynamic grant).

The configured grant-based transmission is a method of performing UL transmission using an uplink shared channel (for example, PUSCH) on the basis of the UL grant configured by the higher layer (for example, configured grant, may be referred to as configured UL grant or the like). In the configured grant-based transmission, a UL resource is already allocated to the UE, and the UE can voluntarily perform UL transmission by using a configured resource, and therefore, implementation of low latency communication can be expected.

The dynamic grant-based transmission may be referred to as a dynamic grant-based PUSCH, UL transmission with dynamic grant, PUSCH with dynamic grant, UL transmission with UL grant, UL grant-based transmission, UL transmission scheduled (for which a transmission resource is configured) by dynamic grant, and the like.

The configured grant-based transmission may be referred to as a configured grant-based PUSCH, UL transmission with configured grant, PUSCH with configured grant, UL transmission without UL grant, UL grant-free transmission, UL transmission scheduled (for which transmission resource is configured) by configured grant, and the like.

Furthermore, the configured grant-based transmission may be defined as one type of UL semi-persistent scheduling (SPS). In the present disclosure, “configured grant” may mutually be replaced with “SPS”, “SPS/configured grant”, and the like.

Several types (type 1, type 2, or the like) are being studied for configured grant-based transmission.

In configured grant type 1 transmission, the parameters used for configured grant-based transmission (which may also be referred to as configured grant-based transmission parameters, configured grant parameters, or the like) are configured in the UE using only higher layer signaling.

In configured grant type 2 transmission, a configured grant parameter is configured to the UE by higher layer signaling. In the configured grant type 2 transmission, the UE may be notified of at least some of the configured grant parameters by physical layer signaling (for example, activation downlink control information (DCI) described later).

The configured grant parameter may be configured in the UE using a ConfiguredGrantConfig information element of RRC. The configured grant parameters may include information identifying the configured grant resource, for example. The configured grant parameter may include, for example, information regarding a configured grant index, time offset, periodicity, a repetition factor (K) of a transport block (TB), and a redundancy version (RV) sequence used for repetition transmission, and the above-mentioned timer.

Here, the periodicity and the time offset each may be represented in units of symbols, slots, subframes, frames, or the like. The periodicity may be indicated by, for example, a given number of symbols. The time offset may be indicated by an offset with respect to a timing of a given index (such as slot number=0 and/or system frame number=0), for example. The repetition transmission factor may be an arbitrary integer, for example, 1, 2, 4, 8, or the like. In a case where the repetition transmission factor is n (>0), the UE may perform configured grant-based PUSCH transmission of a given TB by using n times of transmission occasions.

The UE may determine that one or more configured grants have been triggered if the configured grant type 1 transmission is set. The UE may perform PUSCH transmission by using configured resource for configured grant-based transmission (which may also be referred to as a configured grant resource, a transmission occasion, or the like). Note that, even when the configured grant-based transmission is configured, the UE may skip the configured grant-based transmission when there is no data in the transmission buffer.

When the configured grant type 2 transmission is configured and a given activation signal is notified, the UE may determine that one or more configured grants have been triggered (or activated). The given activation signal (DCI for activation) may be DCI (PDCCH) scrambled by a Cyclic Redundancy Check (CRC) with a given identifier (for example, Configured Scheduling RNTI (CS-RNTI)). Note that the DCI may be used for control such as deactivation and retransmission of the configured grant.

The UE may determine whether or not to perform PUSCH transmission by using the configured grant resource configured in the higher layer on the basis of the given activation signal described above. On the basis of the DCI for deactivating a configured grant or on the expiration (elapse of a given time) of a given timer, the UE may release (which may also be referred to as deactivate, or the like) a resource (PUSCH) corresponding to the configured grant.

Note that, even when the configured grant-based transmission is activated (in an active state), the UE may skip the configured grant-based transmission when there is no data in the transmission buffer.

<Redundancy Version>

In a case where transmission of a plurality of shared channels (for example, PUSCHs) or PUSCH repetition transmission is performed, a given redundancy version (RV) sequence is applied to each PUSCH transmission.

In a case where repetition transmission of the PUSCH (or TB) is performed over a plurality of transmission occasions, the RV sequence applied to the n-th transmission occasion of the TB may be determined on the basis of a given rule. For example, for PUSCH repetition transmission scheduled by a PDCCH (or DCI) that is cyclic redundancy check (CRC)-scrambled using a given radio network temporary identifier (RNTI), the RV sequence may be determined on the basis of information notified by the DCI and an index of a transmission occasion.

The UE may determine the RV (which may be read as an RV index, an RV value, or the like) corresponding to the n-th repetition on the basis of a value of a given field (for example, an RV field) in the DCI for scheduling the repetition of the PUSCH. Note that, in the present disclosure, the n-th repetition may be read as the (n−1) th repetition (for example, the first repetition may be expressed as the 0-th repetition).

For example, the UE may determine the RV index to be applied to the first repetition on the basis of a 2-bit RV field. For example, the value of the RV field being “00”, “01”, “10”, and “11” may correspond to the RV index of the first repetition being “0”, “1”, “2”, and “3”, respectively.

For repeat of the PUSCH, only a specific RV sequence may be supported. The specific RV sequence may be an RV sequence (for example, an RV sequence {#0, #2, #3, #1}) including different RV indices (not including the same RV index). Note that the RV sequence may include one or more RV indices.

In addition, for repeat of the PUSCH, more than one RV sequences may be supported. The more than one RV sequence may include, for example, a first RV sequence {#0, #2, #3, #1}, a second RV sequence {#0, #3, #0, #3}, a third RV sequence {#0, #0, #0, #0}, and the like. The number of applied RV sequences may be set according to a transmission type.

For example, one RV sequence may be applied to dynamic-based PUSCH transmission in which the PUSCH is scheduled by the DCI, and a plurality of RV sequences (for example, the first to the third RV sequences) may be applied to configured grant-based PUSCH transmission.

The UE may configure at least one of more than one RV sequences by higher layer signaling for PUSCH repeat. For example, in configured grant-based PUSCH transmission, at least one of RV sequences {#0, #2, #3, #1}, {#0, #3, #0, #3}, and {#0, #0, #0, #0} may be configured by higher layer signaling. The information regarding the RV sequence may be included in the information regarding the configuration of a configured grant (for example, ConfiguredGrantConfig).

The timing of the initial transmission of the TB (or start occasion) may be determined according to at least one of a given higher layer parameter, a RV sequence to be configured, and a repetition factor K. For example, in a case where the configuration of the configured grant (for example, ConfiguredGrantConfig) is notified, the UE may determine the initial transmission of the TB (which may be referred to as initial transmission) based on a given higher layer parameter (for example, Configuredgrantconfig-Startingfrom RV0).

The given higher layer parameter (for example, Configuredgrantconfig-StartingfromRV0) may be used to notify whether the start of the initial transmission of the TB is allowed from the RV sequence 0 (or whether it is allowed only from the first transmission occasion of K repetitions). If the given higher layer parameter is OFF, the UE may control to perform the initial transmission of the TB from the first transmission occasion of K repetitions.

On the other hand, in other cases (for example, in a case where a given higher layer parameter is ON), the start timing of the initial transmission of the TB may be determined in consideration of at least one of the RV sequence and the repetition factor K to be configured.

Information regarding the RV sequence (for example, repK-RV) and the repetition factor K (for example, RepK) may be included in a configuration of a configured grant (for example, ConfiguredGrantConfig) notified the UE in a higher layer. When a multi configured grant is configured, the RV sequence and the repeat factor K may be separately configured (for example, at least one of different RV sequences and different repetition factors K) for each configured grant.

In addition, a configuration of the configured grant configured in a higher layer may include other information such as resource allocation, periodicity, and a configured grant timer. In a multi configured grant, some parameters may be set separately, and the remaining parameters may be configured in common.

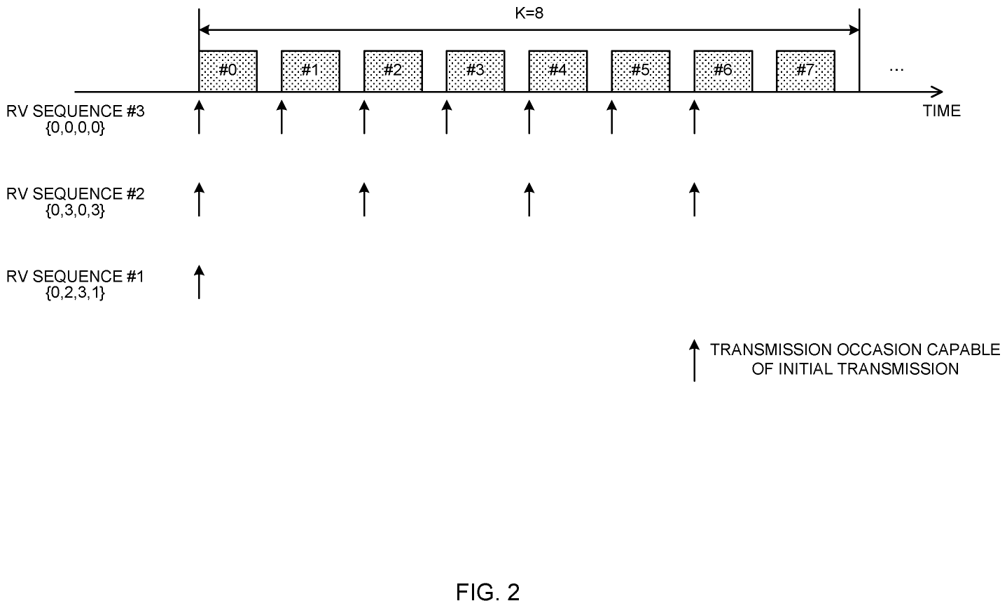

FIG. 2 illustrates an example of a case where the UE determines the transmission occasion (for example, the first transmission occasion) in which the initial transmission of the TB is allowed in consideration of at least one of the RV sequence and the repetition factor K when the given higher layer parameter (for example, Configuredgrantconfig-Startingfrom RV0) is not OFF (for example, in the case of ON). Note that FIG. 2 illustrates a case where the maximum repetition factor K (=8 (k=0 to 7)) supported by the existing system (for example, Rel. 15) is used.

If the first RV sequence {#0, #2, #3, #1} is configured, the initial transmission of the TB starts from the first transmission occasion among the transmission occasions, each corresponding to the K repetitions. Here, the initial transmission can be performed only from the first transmission occasion (for example, #0 (k=0)) among the eight transmission occasions (for example, #0 to #7) included in the range of the periodicity P.

If the second RV sequence {#0, #3, #0, #3} is configured, the initial transmission of the TB can be started from any one of the transmission occasions associated with the given RV index among the transmission occasions, each corresponding to the K repetitions. The given RV index may be RV sequence=0. Here, the initial transmission can be performed from at least one of the first (#0), third (#2), fifth (#4), and seventh (#6) transmission occasions among the eight transmission occasions included in the range of the periodicity P (for example, #0 to #7).

If the third RV sequence {#0, #0, #0, #0} is configured, the initial transmission of the TB can be started from each transmission occasion (in a case of K=1, 2, or 4) among the transmission occasions, each corresponding to the K repetitions, or from a transmission occasion other than the last transmission occasion (in a case of K=8) among the K repetitions. That is, in the case of K=1, 2, or 4, the initial transmission of the TB can be started at any transmission occasion. On the other hand, when K=8, the initial transmission of the TB can be started at any of the transmission occasions (#0 to #6) except the last transmission occasion (#7).

In this way, the initial transmission occasion may be limited to a transmission occasion corresponding to a specific RV value. The specific RV value may be a self-decodable RV. The self-decodable RV may be an RV value (for example, RV=0) including many bits related to system information (systematic bits). By transmitting at least a PUSCH to which the self-decodable RV value is applied, it is possible to increase the probability that decoding can be performed at a base station on the basis of the PUSCH to which the RV is applied.

Incidentally, in a future radio communication system (for example, Rel. 16, 17, and subsequent releases), it is also assumed that a repetition factor supported by repetition transmission is extended (for example, a value greater than eight is supported).

However, in a case where the repetition factor is extended, how to control the configured grant-based repetition transmission (for example, start timing of initial transmission, and the like) has not been sufficiently studied yet. In a case where the initial transmission is not started from an appropriate transmission occasion, there is a possibility that a problem such as a decrease in communication throughput occurs.

Therefore, the present inventors have focused on the extension of the repetition factor, studied the control of the repetition transmission (for example, start timing control of initial transmission) in such a case, and conceived the present embodiment.

Hereinafter, embodiments according to the present disclosure will be described in detail with reference to the drawings. Note that the following respective aspects may be used alone, or may be applied by combining at least two of them. In the following description, an uplink shared channel (for example, the PUSCH) is used as an example, but applicable signals/channels are not limited thereto. For example, the present embodiment may be applied by replacing the PUSCH with the PDSCH and replacing the transmission with the reception.

The following aspects are described by taking a configured grant-based repetition transmission as an example, but are not limited thereto. Furthermore, in the following description, a case where 12 and 16 are supported as the extension of the repetition factor (for example, a repetition factor greater than eight) will be described as an example, but the configurable repetition factor is not limited thereto.

(First Aspect)

In a first aspect, a case will be described in which control of repetition transmission is performed by applying the same rule (or conditions) to repetition transmission in which a plurality of repetition factors larger than a given value is supported.

The UE may determine the transmission occasion for starting the initial transmission of the TB based on at least one of the given higher layer parameter, the RV sequence, and the repetition factor K.

If the given higher layer parameter (for example, Configuredgrantconfig-StartingfromRV0) is OFF, the UE may control to start the initial transmission of the TB from the first transmission occasion among the transmission occasions, each corresponding to the repetition transmission (or the repetition factor K).

On the other hand, in other cases (for example, in a case where a given higher layer parameter is ON), the UE may determine the transmission occasion in which start of initial transmission of the TB is allowed based on at least one of the RV sequence to be configured and the repetition factor K.

<Case of RV Sequence {#0, #2, #3, #1}>

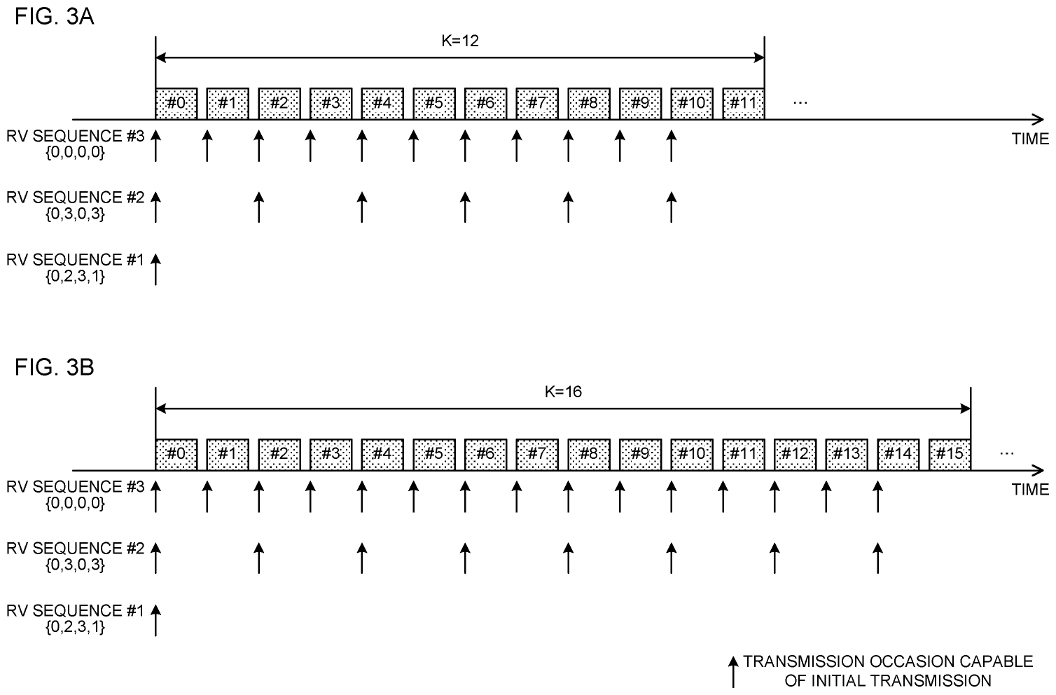

If the first RV sequence {#0, #2, #3, #1} is configured, the initial transmission of the TB may be configured to be started from the first transmission occasion of K repetitions. For example, if the first RV sequence {#0, #2, #3, #1} is configured, the UE may control the initial transmission of the TB to start from the first transmission occasion, regardless of the repetition factor to be configured (see FIGS. 3A and 3B). FIG. 3A illustrates a case where the repetition factor is 12, and FIG. 3B illustrates a case where the repetition factor is 16.

<Case of RV Sequence {#0, #3, #0, #3}>

If the second RV sequence {#0, #3, #0, #3} is configured, the initial transmission of the TB may be allowed to be started from any transmission occasion associated with a given RV index (for example, RV=0) among the K repetitions. For example, if the second RV sequence {#0, #3, #0, #3} is configured, the UE may control to start the initial transmission of the TB from any transmission occasion corresponding to the RV sequence #0 regardless of the repetition factor to be configured (see FIGS. 3A and 3B). FIG. 3A illustrates a case where the repetition factor is 12, and FIG. 3B illustrates a case where the repetition factor is 16.

FIG. 3A illustrates a case where the initial transmission is allowed from at least one of the first (#0), third (#2), fifth (#4), seventh (#6), ninth (#8), and eleventh (#10) transmission occasions among the 12 transmission occasions included in the range of the periodicity P. FIG. 3B illustrates a case where the initial transmission is allowed from at least one of the first (#0), third (#2), fifth (#4), seventh (#6), ninth (#8), eleventh (#10), thirteenth (#12), and fifteenth (#14) transmission occasions among the 16 transmission occasions included in the range of the periodicity P.

<Case of RV Sequence {#0, #0, #0, #0}>

If the third RV sequence {#0, #0, #0, #0} is configured, the transmission occasion in which the initial transmission of the TB is allowed may be determined based on the value of the repetition factor (or range).

For example, if a third RV sequence {#0, #0, #0, #0} is configured and the repetition factor is less than a given value, the start of the initial transmission of the TB may be allowed from any transmission occasion, each corresponding to K repetitions. The given value may be, for example, 8. In this case, when 2 to 7 is set as the repetition factor, the UE may start the initial transmission from any of the transmission occasions corresponding to each repetition transmission.

On the other hand, when the repetition factor is a given value or more (for example, eight or more (here, K=8, 12, or 16)), the start of the initial transmission of the TB may be allowed from each transmission occasion other than the last transmission occasion among the K repetitions. For example, in a case where eight or more is set as the repetition factor, the UE may start the initial transmission from any transmission occasion other than the last transmission occasion among the transmission occasions corresponding to the respective repetition transmission (see FIGS. 3A and 3B). FIG. 3A illustrates a case where the repetition factor is 12, and FIG. 3B illustrates a case where the repetition factor is 16.

As a result, in a case where the repetition factor is a given value or more, at least a plurality of TBs can be transmitted in the repetition transmission to which the repetition factor of the given value or more is applied.

(Second Aspect)

In a second aspect, a case will be described in which control of repetition transmission is performed by applying the rule (or conditions) for each repetition factor to the repetition transmission in which a plurality of repetition factors larger than a given value is supported.

The UE may determine the transmission occasion for starting the initial transmission of the TB based on at least one of the given higher layer parameter, the RV sequence, and the repetition factor K.

If the given higher layer parameter (for example, Configuredgrantconfig-StartingfromRV0) is OFF, the UE may control to start the initial transmission of the TB from the first transmission occasion among the transmission occasions, each corresponding to the repetition transmission (or the repetition factor K).

On the other hand, in other cases (for example, in a case where a given higher layer parameter is ON), the UE may determine the transmission occasion in which start of initial transmission of the TB is allowed based on at least one of the RV sequence to be configured and the repetition factor K.

<Case of RV Sequence {#0, #2, #3, #1}>

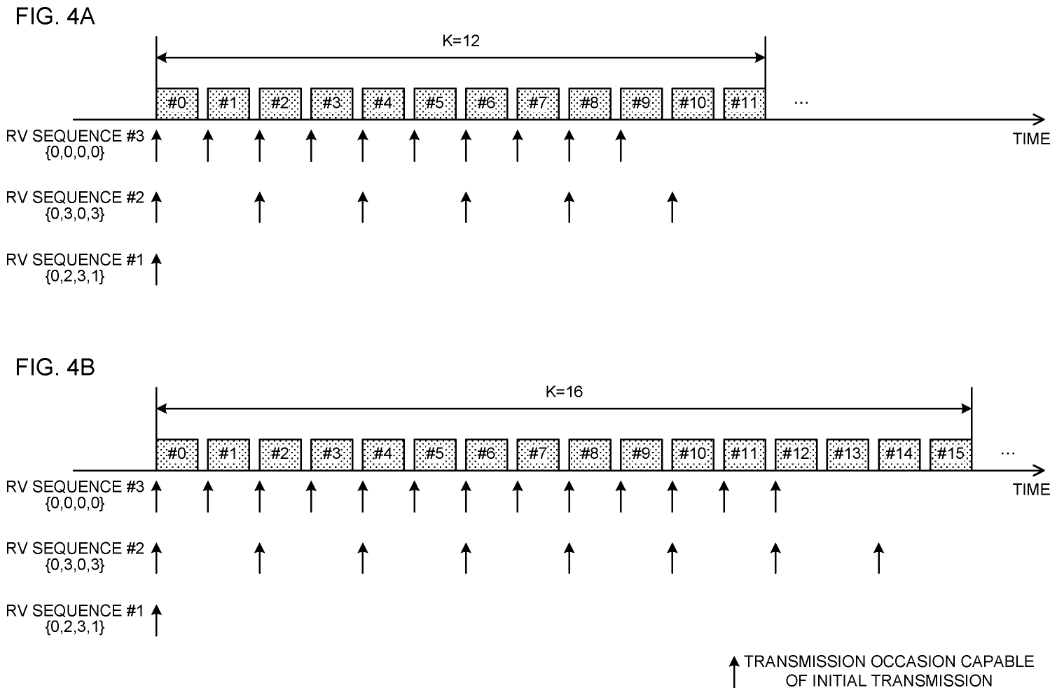

If the first RV sequence {#0, #2, #3, #1} is configured, the initial transmission of the TB may be configured to be started from the first transmission occasion of K repetitions. For example, if the first RV sequence {#0, #2, #3, #1} is configured, the UE may control the initial transmission of the TB to start from the first transmission occasion, regardless of the repetition factor to be configured (see FIGS. 4A and 4B). FIG. 4A illustrates a case where the repetition factor is 12, and FIG. 4B illustrates a case where the repetition factor is 16.

<Case of RV Sequence {#0, #3, #0, #3}>

If the second RV sequence {#0, #3, #0, #3} is configured, the initial transmission of the TB may be allowed to be started from any transmission occasion associated with a given RV index (for example, RV=0) among the K repetitions. For example, if the second RV sequence {#0, #3, #0, #3} is configured, the UE may control to start the initial transmission of the TB from any transmission occasion corresponding to the RV sequence #0 regardless of the repetition factor to be configured (see FIGS. 4A and 4B). FIG. 4A illustrates a case where the repetition factor is 12, and FIG. 4B illustrates a case where the repetition factor is 16.

FIG. 4A illustrates a case where the initial transmission is allowed from at least one of the first (#0), third (#2), fifth (#4), seventh (#6), ninth (#8), and eleventh (#10) transmission occasions among the 12 transmission occasions included in the range of the periodicity P. FIG. 4B illustrates a case where the initial transmission is allowed from at least one of the first (#0), third (#2), fifth (#4), seventh (#6), ninth (#8), eleventh (#10), thirteenth (#12), and fifteenth (#14) transmission occasions among the 16 transmission occasions included in the range of the periodicity P.

<Case of RV Sequence {#0, #0, #0, #0}>

If the third RV sequence {#0, #0, #0, #0} is configured, the transmission occasion in which the initial transmission of the TB is allowed may be determined based on the value of the repetition factor (or range).

For example, if a third RV sequence {#0, #0, #0, #0} is configured and the repetition factor is less than a given value, the start of the initial transmission of the TB may be allowed from any transmission occasion, each corresponding to K repetitions. The given value may be, for example, 8. In this case, when 2 to 7 is set as the repetition factor, the UE may start the initial transmission from any of the transmission occasions corresponding to each repetition transmission.

On the other hand, when the repetition factor is a given value or more (for example, eight or more (here, K=8, 12, or 16)), the start of the initial transmission of the TB may be allowed from each transmission occasion other than the given transmission occasion (or excluding the given transmission occasion) among the K repetitions.

The given transmission occasion may be set differently for each value of the repetition factor. For example, the number of transmission occasions in which the initial transmission is restricted may be determined according to the value of the repetition factor. As an example, the number of transmission occasions in which the initial transmission is restricted may be set to increase as the value of the repetition factor increases.

When the repetition transmission factor is eight, the start of the initial transmission of the TB may be allowed from each transmission occasion other than the last transmission occasion of the eight transmission occasions (or excluding the last transmission occasion) (see FIG. 2). Note that the number of transmission occasions in which the initial transmission is restricted is not limited to one.

When the repetition transmission factor is 12, the start of the initial transmission of the TB may be allowed from each transmission occasion other than the last two transmission occasions of the 12 transmission occasions (or excluding the last two transmission occasions) (see FIG. 4A). Here, a case where the initial transmission is allowed from the transmission occasions (#0 to #9) excluding the transmission occasions #10 and #11 is illustrated. Note that the number of transmission occasions in which the initial transmission is restricted is not limited to two.

When the repetition transmission factor is 16, the start of the initial transmission of the TB may be allowed from each transmission occasion other than the last three transmission occasions of the 16 transmission occasions (or excluding the last three transmission occasions) (see FIG. 4B). Here, a case where the initial transmission is allowed from the transmission occasions (#0 to #12) excluding the transmission occasions #13 and #15 is illustrated. Note that the number of transmission occasions in which the initial transmission is restricted is not limited to three.

Note that the number of transmission occasions in which the initial transmission is restricted in each repetition factor of a given value or more may be defined in a specification in advance, or may be notified from the base station to the UE by higher layer signaling or the like.

As described above, by controlling the transmission occasion in which the initial transmission is restricted according to the value of the repetition factor, at least a given ratio (for example, K/4) of the TB can be transmitted to the base station in each repetition factor. As a result, the base station can appropriately determine the TB (for example, the configured grant-based PUSCH) transmitted from the UE. As a result, retransmission or the like of the PUSCH transmission based on the configured grant-based can be performed with a low latency.

<Variations>

Note that, FIGS. 4A and 4B illustrate a case where if the second RV sequence {#0, #3, #0, #3} is configured, the start of the initial transmission is allowed from any one of the transmission occasions associated with RV=0 among the K repetitions, however, the present invention is not limited thereto. For example, if the second RV sequence {#0, #3, #0, #3} is configured, the initial transmission may be configured not to be allowed in the transmission occasion in which the initial transmission is restricted in the third RV sequence {#0, #0, #0, #0}.

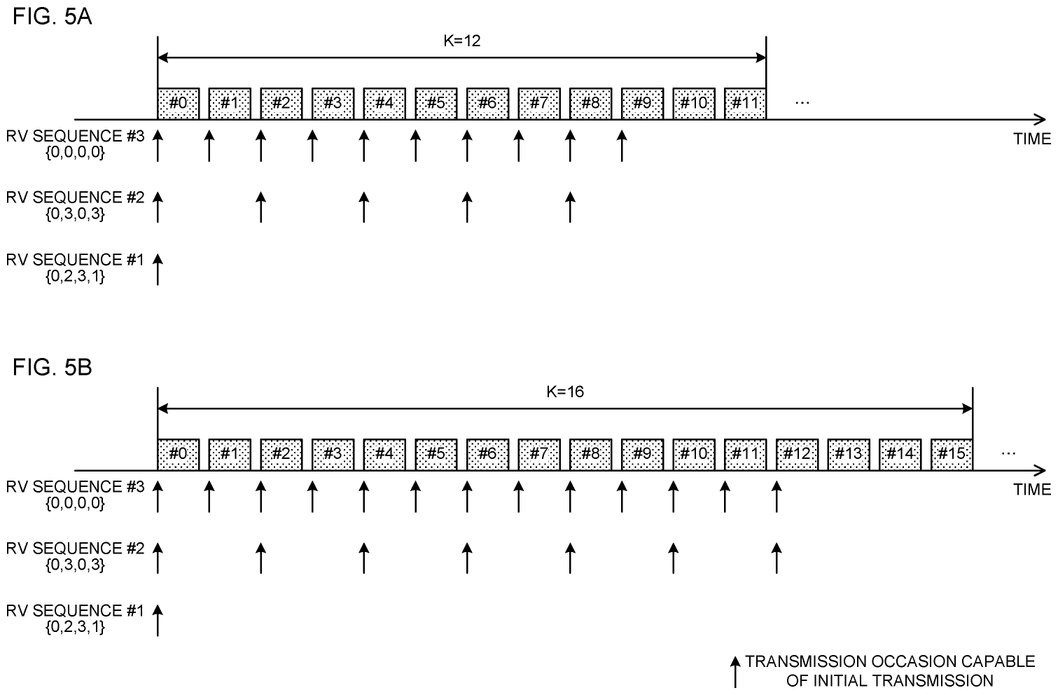

If the second RV sequence {#0, #3, #0, #3} and the repetition transmission factor are set to 12, the start of the initial transmission may be allowed from the transmission occasion associated with RV=0 among the transmission occasions excluding the last two transmission occasions of the 12 transmission occasions (see FIG. 5A). Here, the initial transmission may be allowed from at least one of the first (#0), third (#2), fifth (#4), seventh (#6), and ninth (#8) transmission occasions among the 12 transmission occasions included in the range of the periodicity P.

If the second RV sequence {#0, #3, #0, #3} and the repetition transmission factor are 16, the start of the initial transmission may be allowed from the transmission occasion associated with RV=0 among the transmission occasions excluding the last three transmission occasions of the 16 transmission occasions (see FIG. 5B). Here, illustrated is a case where the initial transmission is allowed from at least one of the first (#0), third (#2), fifth (#4), seventh (#6), ninth (#8), eleventh (#10), and thirteenth (#12) transmission occasions among the 16 transmission occasions included in the range of the periodicity P.

As a result, even when any RV sequence is set in each repetition factor, at least a given ratio (for example, K/4) of TBs can be transmitted to the base station.

(Third Aspect)

In a third aspect, a case will be described in which control of repetition transmission is performed by applying different rules (or conditions) only to repetition transmission using a specific repetition factor (one repetition factor).

The UE may determine the transmission occasion for starting the initial transmission of the TB based on at least one of the given higher layer parameter, the RV sequence, and the repetition factor K.

If the given higher layer parameter (for example, Configuredgrantconfig-StartingfromRV0) is OFF, the UE may control to start the initial transmission of the TB from the first transmission occasion among the transmission occasions, each corresponding to the repetition transmission (or the repetition factor K).

On the other hand, in other cases (for example, in a case where a given higher layer parameter is ON), the UE may determine the transmission occasion in which start of initial transmission of the TB is allowed based on at least one of the RV sequence to be configured and the repetition factor K.

<Case of RV Sequence {#0, #2, #3, #1}>

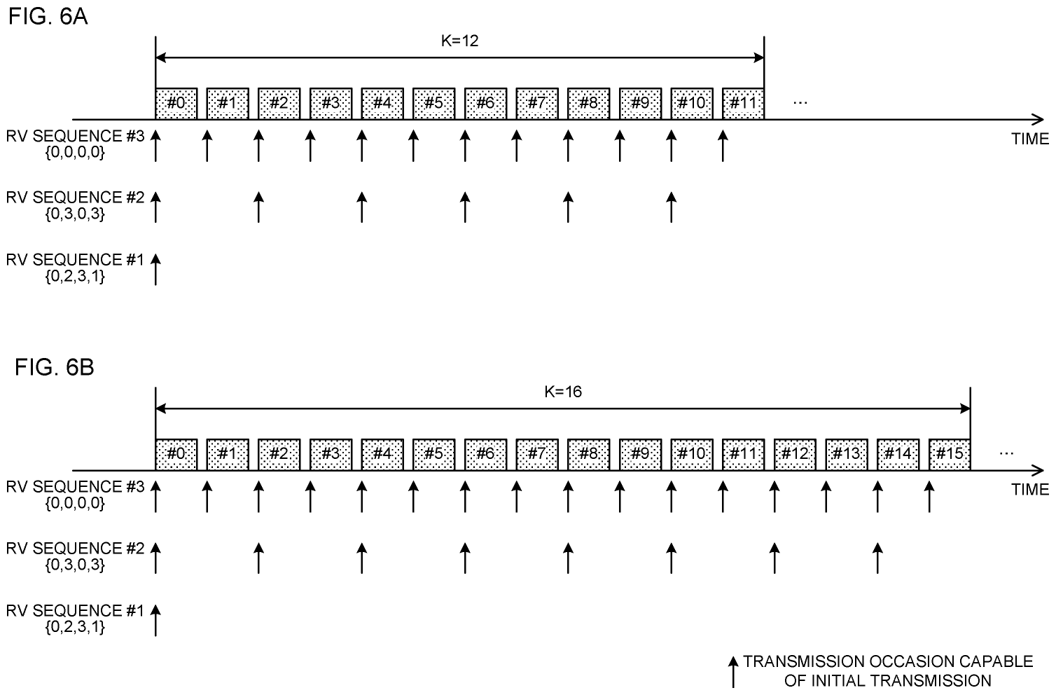

If the first RV sequence {#0, #2, #3, #1} is configured, the initial transmission of the TB may be configured to be started from the first transmission occasion of K repetitions. For example, if the first RV sequence {#0, #2, #3, #1} is configured, the UE may control the initial transmission of the TB to start from the first transmission occasion, regardless of the repetition factor to be configured (see FIGS. 6A and 6B). FIG. 6A illustrates a case where the repetition factor is 12, and FIG. 6B illustrates a case where the repetition factor is 16.

<Case of RV Sequence {#0, #3, #0, #3}>

If the second RV sequence {#0, #3, #0, #3} is configured, the initial transmission of the TB may be allowed to be started from any transmission occasion associated with a given RV index (for example, RV=0) among the K repetitions. For example, if the second RV sequence {#0, #3, #0, #3} is configured, the UE may control to start the initial transmission of the TB from any transmission occasion corresponding to the RV sequence #0 regardless of the repetition factor to be configured (see FIGS. 6A and 6B). FIG. 6A illustrates a case where the repetition factor is 12, and FIG. 6B illustrates a case where the repetition factor is 16.

FIG. 6A illustrates a case where the initial transmission is allowed from at least one of the first (#0), third (#2), fifth (#4), seventh (#6), ninth (#8), and eleventh (#10) transmission occasions among the 12 transmission occasions included in the range of the periodicity P. FIG. 6B illustrates a case where the initial transmission is allowed from at least one of the first (#0), third (#2), fifth (#4), seventh (#6), ninth (#8), eleventh (#10), thirteenth (#12), and fifteenth (#14) transmission occasions among the 16 transmission occasions included in the range of the periodicity P.

<Case of RV Sequence {#0, #0, #0, #0}>

If the third RV sequence {#0, #0, #0, #0} is configured, the transmission occasion in which the initial transmission of the TB is allowed may be determined based on the value of the repetition factor (for example, whether or not the repetition factor is a given value).

For example, if a third RV sequence {#0, #0, #0, #0} is configured and the repetition factor is other than a given value, the start of the initial transmission of the TB may be allowed from any transmission occasion, each corresponding to K repetitions. The given value may be, for example, 8.

When other than eight (for example, 2 to 7, 12, 16, or the like) is set as the repetition factor, the UE may start the initial transmission from any of the transmission occasions corresponding to each repetition transmission (see FIGS. 6A and 6B). FIG. 6A illustrates a case where the repetition factor is 12, and FIG. 6B illustrates a case where the repetition factor is 16.

On the other hand, when the repetition factor is a given value (for example, K=8), the start of the initial transmission of the TB may be allowed from each transmission occasion other than the last transmission occasion among the eight repetitions. For example, in a case where eight is set as the repetition factor, the UE may start the initial transmission from any transmission occasion other than the last transmission occasion among the transmission occasions corresponding to the respective repetition transmission.

(Fourth Aspect)

In a fourth aspect, a case will be described in which control of repetition transmission is performed by applying the same rule (or conditions) regardless of repetition factors.

The UE may determine the transmission occasion for starting the initial transmission of the TB based on at least one of the given higher layer parameter, the RV sequence, and the repetition factor K.

If the given higher layer parameter (for example, Configuredgrantconfig-StartingfromRV0) is OFF, the UE may control to start the initial transmission of the TB from the first transmission occasion among the transmission occasions, each corresponding to the repetition transmission (or the repetition factor K).

On the other hand, in other cases (for example, in a case where a given higher layer parameter is ON), the UE may determine the transmission occasion in which start of initial transmission of the TB is allowed based on the RV sequence to be configured.

<Case of RV Sequence {#0, #2, #3, #1}>

If the first RV sequence {#0, #2, #3, #1} is configured, the initial transmission of the TB may be configured to be started from the first transmission occasion of K repetitions. For example, if the first RV sequence {#0, #2, #3, #1} is configured, the UE may control the initial transmission of the TB to start from the first transmission occasion, regardless of the repetition factor to be configured.

<Case of RV Sequence {#0, #3, #0, #3}>

If the second RV sequence {#0, #3, #0, #3} is configured, the initial transmission of the TB may be allowed to be started from any transmission occasion associated with a given RV index (for example, RV=0) among the K repetitions. For example, if the second RV sequence {#0, #3, #0, #3} is configured, the UE may control to start the initial transmission of the TB from any transmission occasion corresponding to the RV sequence #0 regardless of the repetition factor to be configured.

<Case of RV Sequence {#0, #0, #0, #0}>

If the third RV sequence {#0, #0, #0, #0} is configured, the initial transmission of the TB may be allowed to be started from any transmission occasion among the K repetitions. For example, if the third RV sequence {#0, #0, #0, #0} is configured, the UE may control to start the initial transmission of the TB from any transmission occasion each corresponding to the respective repetition factor regardless of the repetition factor to be configured.

(Variations)

The first to fourth aspects described above may be applied in combination. For example, the UE may switch at least two of the first to the fourth aspects to be applied. In this case, the base station may notify or configure the repetition transmission control that the UE applies (the first to fourth aspects) to the UE by using a higher layer parameter or the like.

The UE supporting the existing system (for example, Rel. 15) may be configured to always apply a given method (for example, the second aspect) when the configured grant is configured. On the other hand, the UE supporting Rel. 16 and subsequent releases may apply at least one of the first to fourth aspects when the configured grant is configured and the repetition factor eight (or eight or more) is supported.

Further, when the repetition factor is not configured (for example, in a case where the repetition factor K is 1), the fourth aspect may be applied. For example, the UE may apply the fourth aspect to the configured grant-based PUSCH transmission that periodically transmits.

(Radio Communication System)

Hereinafter, a configuration of a radio communication system according to one embodiment of the present disclosure will be described. In this radio communication system, communication is performed using one or a combination of the radio communication methods according to the herein-contained embodiments of the present disclosure.

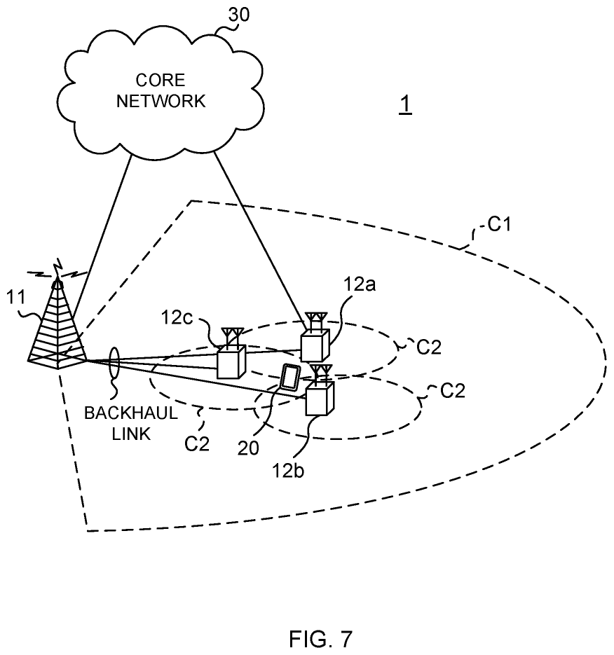

FIG. 7 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are arranged in the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10”, unless these are distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range (frequency range 1 (FR1)) and a second frequency range (frequency range 2 (FR2)). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like of the FR1 and FR2 are not limited thereto, and, for example, FR1 may correspond to a frequency range higher than FR2.

Further, the user terminal 20 may perform communication on each CC using at least one of time division duplex (TDD) and frequency division duplex (FDD).

The plurality of base stations 10 may be connected to each other in a wired manner (for example, an optical fiber, an X2 interface, or the like in compliance with common public radio interface (CPRI)) or in a wireless manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), and the like.

The user terminal 20 may be a terminal corresponding to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that, in the radio communication system 1, another radio access method (for example, another single carrier transmission method or another multi-carrier transmission method) may be used as the UL and DL radio access methods.

In the radio communication system 1, a downlink shared channel (physical downlink shared channel (PDSCH)) shared by the user terminals 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by the user terminals 20, an uplink control channel (physical uplink control channel (PUCCH)), a random access channel (physical random access channel (PRACH)), and the like may be used as uplink channels.

User data, higher layer control information, a system information block (SIB), and the like are transmitted on the PDSCH. User data, higher layer control information, and the like may be transmitted on the PUSCH. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH and the PUSCH.

Note that, the DCI for scheduling the PDSCH may be referred to as DL assignment, DL DCI, or the like, and the DCI for scheduling the PUSCH may be referred to as UL grant, UL DCI, or the like. Note that, the PDSCH may be replaced with DL data, and the PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. The UE may monitor the CORESET associated with a certain search space on the basis of search space configuration.

One search space may correspond to a PDCCH candidate corresponding to one or more aggregation levels. One or more search spaces may be referred to as a search space set. Note that the terms “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), and scheduling request (SR) may be transmitted on the PUCCH. A random access preamble for establishing connection with a cell may be transmitted on the PRACH.

Note that, in the present disclosure, downlink, uplink, and the like may be expressed without “link”. Furthermore, various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals)”.

(Base Station)

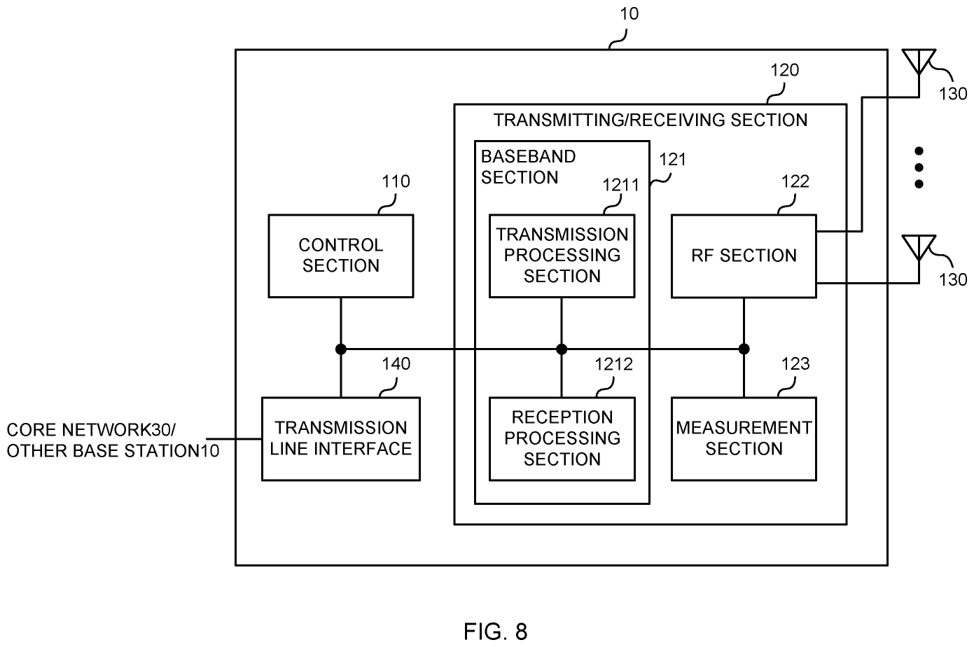

FIG. 8 is a diagram illustrating an example of a configuration of the base station according to one embodiment. The base station 10 includes a control section 110, a transmitting/receiving section 120, a transmission/reception antenna 130, and a transmission line interface 140. Note that one or more control sections 110, one or more transmitting/receiving sections 120, one or more transmitting/receiving antennas 130, and one or more transmission line interfaces 140 may be provided.

Note that, although this example mainly describes functional blocks of a characteristic part of the present embodiment, it may be assumed that the base station 10 includes other functional blocks that are necessary for radio communication as well. A part of processing performed by each section described below may be omitted.

The control section 110 controls the entire base station 10. The control section 110 can include a controller, a control circuit, and the like, which are described on the basis of common recognition in the technical field related to the present disclosure.

The control section 110 may control signal generation, scheduling (for example, resource allocation or mapping), and the like. The control section 110 may control transmission/reception, measurement, and the like using the transmitting/receiving section 120, the transmitting/receiving antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, state management of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 120 may be configured as an integrated transmitting/receiving section, or may include a transmitting section and a receiving section. The transmitting section may include the transmission processing section 1211 and the RF section 122. The receiving section may include the reception processing section 1212, the RF section 122, and the measurement section 123.

The transmitting/receiving antenna 130 can include an antenna, which is described on the basis of common recognition in the technical field related to the present disclosure, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam and a Rx beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency range, filtering processing, amplification, and the like on the baseband signal, and may transmit a signal in the radio frequency range via the transmitting/receiving antenna 130.

Meanwhile, the transmitting/receiving section 120 (RF section 122) may perform amplification, filtering processing, demodulation to a baseband signal, and the like on the signal in the radio frequency range received by the transmitting/receiving antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may perform transmission/reception of a signal (backhaul signaling) to/from an apparatus included in the core network 30, another base station 10, or the like, and may perform acquisition, transmission, or the like of user data (user plane data), control plane data, and the like for the user terminal 20.

Note that, the transmitting section and the receiving section of the base station 10 in the present disclosure may include at least one of the transmitting/receiving section 120, the transmitting/receiving antenna 130, and the transmission line interface 140.

The transmitting/receiving section 120 may transmit the information regarding the repetition factor and the information regarding the redundancy version sequence used for the repetition transmission. When the repetition factor is greater than eight, the transmitting/receiving section 120 may receive a transport block in which initial transmission is started from a transmission occasion selected based on the redundancy version sequence and the repetition factor.

When the repetition factor greater than eight is configured, the control section 110 may determine to receive a transport block in which initial transmission is started in the transmission occasion selected based on the redundancy version sequence and the repetition factor.

(User Terminal)

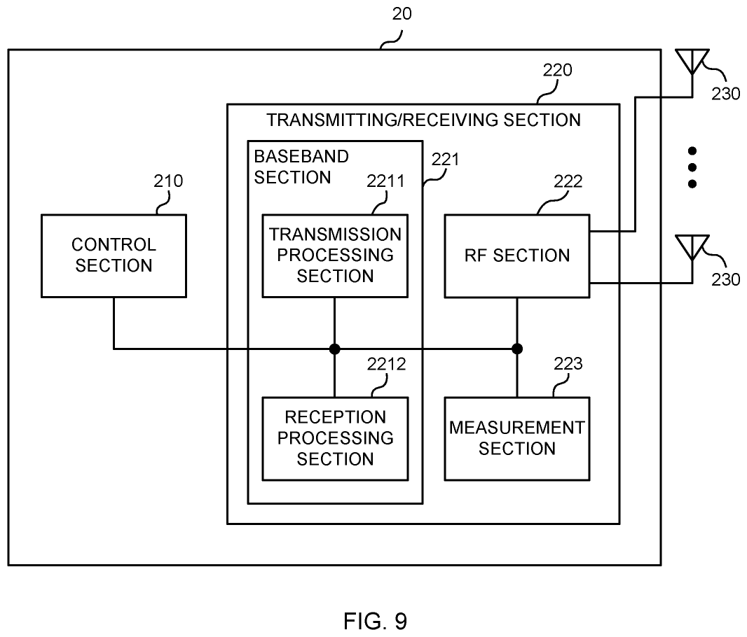

FIG. 9 is a diagram illustrating an example of a configuration of the user terminal according to one embodiment. The user terminal 20 includes a control section 210, a transmitting/receiving section 220, and a transmission/reception antenna 230. Note that, one or more each of the control sections 210, the transmitting/receiving sections 220, and the transmitting/receiving antennas 230 may be included.

Note that, although this example mainly describes functional blocks of a characteristic part of the present embodiment, it may be assumed that the user terminal 20 includes other functional blocks that are necessary for radio communication as well. A part of processing performed by each section described below may be omitted.

The control section 210 controls the entire user terminal 20. The control section 210 can include a controller, a control circuit, and the like that are described on the basis of common recognition in the technical field related to the present disclosure.

The control section 210 may control signal generation, mapping, and the like. The control section 210 may control transmission/reception, measurement, and the like using the transmitting/receiving section 220 and the transmitting/receiving antenna 230. The control section 210 may generate data, control information, a sequence, and the like to be transmitted as signals, and may transfer the data, control information, sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmitting/receiving antenna 230 can include an antenna described on the basis of common recognition in the technical field related to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam or a Rx beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

Note that, whether or not to apply DFT processing may be determined on the basis of configuration of transform precoding. If transform precoding is enabled for a channel (for example, PUSCH), the transmitting/receiving section 220 (transmission processing section 2211) may perform DFT processing as the transmission processing to transmit the channel by using a DFT-s-OFDM waveform, and if not, DFT processing does not have to be performed as the transmission processing.

The transmitting/receiving section 220 (RF section 222) may perform modulation to a radio frequency range, filtering processing, amplification, and the like on the baseband signal, to transmit a signal in the radio frequency range via the transmitting/receiving antenna 230.

Meanwhile, the transmitting/receiving section 220 (RF section 222) may perform amplification, filtering processing, demodulation to a baseband signal, and the like on the signal in the radio frequency range received by the transmitting/receiving antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may include at least one of the transmitting/receiving section 220 and the transmitting/receiving antenna 230.

The transmitting/receiving section 220 may receive the information regarding the repetition factor and the information regarding the redundancy version sequence used for the repetition transmission.

When the repetition factor is greater than 8, the control section 210 may determine a transmission occasion at which the initial transmission of the transport block can be started from a plurality of transmission occasions corresponding to the repetition factor based on at least one of the redundancy version sequence and the repetition factor.

For example, when the repetition factor is greater than eight, in all configurable redundancy versions, the control section 210 may determine a transmission occasion at which the initial transmission can be started according to the same condition as in a case where the repetition factor is eight.

Alternatively, when the repetition factor is greater than eight, in a specific redundancy version sequence, the control section 210 may determine a transmission occasion at which the initial transmission can be started according to a condition different from that as in a case where the repetition factor is eight. When a plurality of repetition factors having a value of eight or more is supported, the number of transmission occasions for which the initial transmission cannot be started in a plurality of transmission occasions corresponding to the respective repetition factors may be separately configured.

(Hardware Configuration)

Note that the block diagrams that have been used to describe the above embodiments illustrate blocks in functional units. These functional blocks (components) may be implemented in arbitrary combinations of at least one of hardware and software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional blocks may be implemented by combining software with the one apparatus or the plurality of apparatuses.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, and assigning. For example, a functional block (component) that has a transmission function may be referred to as a transmitting section (transmitting unit), a transmitter, and the like. In any case, as described above, the implementation method is not particularly limited.

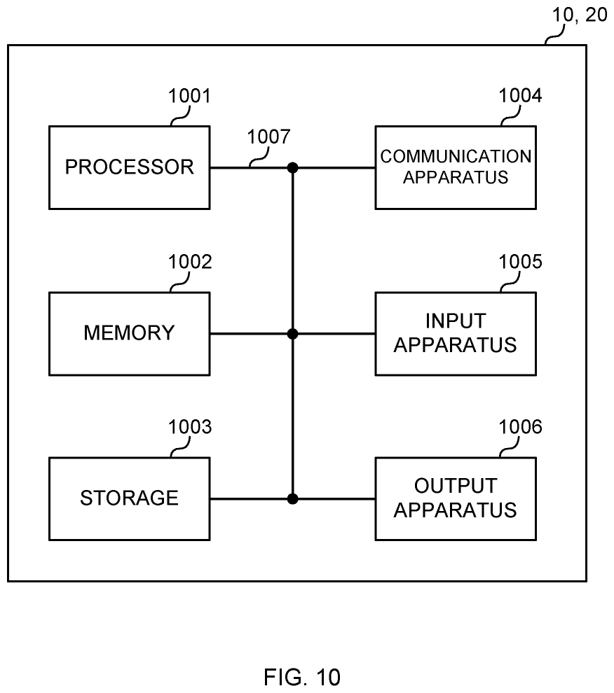

For example, the base station, the user terminal, and so on according to one embodiment of the present disclosure may function as a computer that executes the processing of the radio communication method of the present disclosure. FIG. 10 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that, in the present disclosure, the wording such as an apparatus, a circuit, a device, and a section, and a unit can be replaced with each other. The base station 10 and the user terminal 20 may have the hardware configuration with one or a plurality of apparatuses in the figure or without some apparatuses.

For example, although only one processor 1001 is illustrated, a plurality of processors may be provided. Further, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by the processor 1001. For example, the processor 1001 performs operations by causing a given software (program) to be read on hardware such as a memory 1002 to control communication via a communication apparatus 1004 and control at least one of reading and writing of data in the memory 1002 and a storage 1003.

The processor 1001 controls the entire computer by, for example, running an operating system. The processor 1001 may be configured by a central processing unit (CPU) including an interface with peripheral equipment, a control apparatus, an operation apparatus, a register, and the like. For example, at least a part of the above-described control unit 110 (210), transmission/reception unit 120 (220), and the like may be implemented by the processor 1001.

The processor 1001 reads a program (program code), a software module, data, and the like from at least one of the storage 1003 and the communication apparatus 1004 into the memory 1002, and executes various pieces of processing in according therewith. As the program, a program that causes a computer to execute at least a part of the operation described in the above-described embodiment is used. For example, the control unit 110 (210) may be implemented by a control program that is stored in the memory 1002 and operates in the processor 1001, and other functional blocks may be similarly implemented.

The memory 1002 is a computer-readable recording medium, and may include at least one of, for example, a read only memory (ROM), an erasable programmable rom (EPROM), an electrically EPROM (EEPROM), a random access memory (RAM), and other appropriate storage media. The memory 1002 may be referred to as a register, a cache, a main memory (primary storage apparatus), and the like. The memory 1002 can store a program (program code), a software module, and the like, which can be executed for implementing the radio communication method according to one embodiment of the present disclosure.

The storage 1003 is a computer-readable recording medium, and may include at least one of, for example, a flexible disk, a floppy (registered trademark) disk, a magneto-optical disk (e.g., compact disc (compact disc ROM (CD-ROM) and the like), digital versatile disc, Blu-ray (registered trademark) disk), a removable disk, a hard disk drive, a smart card, a flash memory device (e.g., card, stick, and key drive), a magnetic stripe, a database, a server, and other appropriate storage media. The storage 1003 may be referred to as an auxiliary storage apparatus.

The communication apparatus 1004 is hardware (transmission/reception device) for performing inter-computer communication via at least one of a wired network or a radio network, and is referred to as, for example, a network device, a network controller, a network card, and a communication module. The communication apparatus 1004 may include a high frequency switch, a duplexer, a filter, a frequency synthesizer, and the like in order to implement, for example, at least one of frequency division duplex (FDD) and time division duplex (TDD). For example, the transmitting/receiving section 120 (220), the transmitting/receiving antenna 130 (230), and the like described above may be implemented by the communication apparatus 1004. The transmission/reception unit 120 (220) may be physically or logically implemented by a transmission unit 120a (220a) and a reception unit 120b (220b).

An input apparatus 1005 is an input device (e.g., keyboard, mouse, microphone, switch, button, and sensor) for receiving input from the outside. The output apparatus 1006 is an output device that performs output to the outside (for example, a display, a speaker, a light emitting diode (LED) lamp, or the like). Note that the input apparatus 1005 and the output apparatus 1006 may have integrated (e.g., touch panel).

Each apparatus such as the processor 1001 and the memory 1002 is connected by a bus 1007 for communicating information. The bus 1007 may include a single bus or different buses between apparatuses.

The base station 10 and the user terminal 20 may include hardware such as a microprocessor, a digital signal processor (DSP), an application specific integrated circuit (ASIC), a programmable logic device (PLD), and a field programmable gate array (FPGA), and a part or all of each functional block may be implemented by the hardware. For example, the processor 1001 may be implemented with at least one of these pieces of hardware.

(Variations)

Note that terms described in the present disclosure and terms necessary for understanding the present disclosure may be replaced with terms that have the same or similar meanings. For example, a channel, a symbol, and a signal (signal or signaling) may be replaced interchangeably. Further, the signal may be a message. The reference signal can be abbreviated as an RS, and may be referred to as a pilot, a pilot signal, and the like, depending on which standard applies. A component carrier (CC) may be referred to as a cell, a frequency carrier, a carrier frequency, and the like.

A radio frame may include one or a plurality of periods (frames) in a time domain. Each of the one or more periods (frames) included in the radio frame may be referred to as a subframe. Further, the subframe may include one or more slots in the time domain. The subframe may be a fixed time length (e.g., 1 ms) that does not depend on numerology.

Here, the numerology may be a communication parameter applied to at least one of transmission and reception of a signal or a channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in a frequency domain, specific windowing processing performed by a transceiver in the time domain, and the like.

The slot may include one or a plurality of symbols (e.g., orthogonal frequency division multiplexing (OFDM) symbol and single carrier frequency division multiple access (SC-FDMA) symbol) in the time domain. The slot may be a time unit based on numerology.

The slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. PDSCH (or PUSCH) transmitted by using a mini slot may be referred to as PDSCH (PUSCH) mapping type B.

All of a radio frame, a subframe, a slot, a mini slot, and a symbol represent a time unit at the time of transmitting a signal. The radio frame, the subframe, the slot, the mini slot, and the symbol may be called by other applicable names, respectively. Note that a time unit such as the frame, the subframe, the slot, the mini slot, and the symbol in the present disclosure may be replaced with each other.

For example, one subframe may be referred to as TTI. A plurality of consecutive subframes may be referred to as TTI. One slot or one mini slot may be referred to as TTI. That is, at least one of the subframe and the TTI may be a subframe (1 ms) in the existing LTE, may be a period shorter than 1 ms (for example, one to thirteen symbols), or may be a period longer than 1 ms. Note that a unit that represents TTI may be referred to as a slot, a mini slot, and the like, instead of the subframe.

Here, TTI refers to a minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTI is not limited thereto.

TTI may be a transmission time unit of a channel-encoded data packet (transport block), a code block, a codeword, and the like, or may be a processing unit of scheduling, link adaptation, and the like. Note that, when TTI is given, a time interval (e.g., number of symbols) in which the transport block, the code block, the codeword, and the like are actually mapped may be shorter than TTI.

Note that, when one slot or one mini slot is referred to as TTI, one or more TTIs (i.e., one or more slots or one or more mini slots) may be the minimum time unit of scheduling. The number of slots (number of mini slots) that constitutes the minimum time unit of the scheduling may be controlled.

TTI having a time length of 1 ms may be referred to as usual TTI (TTI in 3GPP Rel. 8 to 12), normal TTI, long TTI, a usual subframe, a normal subframe, a long subframe, a slot, and the like. TTI shorter than the usual TTI may be referred to as shortened TTI, short TTI, partial TTI (or fractional TTI), a shortened subframe, a short subframe, a mini slot, a subslot, a slot, and the like.

Note that the long TTI (e.g., usual TTI and subframe) may be replaced with TTI having a time length more than 1 ms, and the short TTI (e.g., shortened TTI) may be replaced with TTI having a TTI length less than the TTI length of the long TTI and not less than 1 ms.

A resource block (RB) is a resource allocation unit in the time domain and the frequency domain, and may include one or a plurality of consecutive subcarriers in the frequency domain. The number of subcarriers included in the RB may be the same regardless of the numerology, and may be twelve, for example. The number of subcarriers in RB may be determined based on numerology.

RB may include one or a plurality of symbols in the time domain, and may have a length of one slot, one mini slot, one subframe, or one TTI. Each of one TTI, one subframe, and the like each may include one or a plurality of resource blocks.

Note that one or a plurality of RBs may be referred to as a physical resource block (Physical RB (PRB)), a subcarrier group (SCG), a resource element group (REG), a PRB pair, an RB pair, and the like.

A resource block may include one or a plurality of resource elements (REs). For example, one RE may be a radio resource domain of one subcarrier and one symbol.

The bandwidth part (BWP) (which may be called partial bandwidth and the like) may represent a subset of consecutive common resource blocks (RB) for certain numerology in a certain carrier. Here, the common RB may be specified by the index of the RB based on a common reference point of the carrier. PRB may be defined by certain BWP, and numbered within the BWP.

BWP may include BWP for UL (UL BWP) and BWP for DL (DL BWP). In UE, one or a plurality of BWPs may be set in one carrier.

At least one of the set BWPs may be active, and UE is not required to assume transmission/reception of a given signal/channel outside the active BWP. Note that cell, carrier, and the like in the present disclosure may be replaced with BWP.

Note that the structures of the above-described radio frame, subframe, slot, mini slot, symbol, and the like are merely examples. For example, configurations of the number of subframes in a radio frame, the number of slots per subframe or radio frame, the number of mini slots in a slot, the number of symbols and RBs in a slot or a mini slot, the number of subcarriers in RB, the number of symbols in TTI, a symbol length, a cyclic prefix (CP) length, and the like can be variously changed.

The information, parameters, and the like described in the present disclosure may be represented in an absolute value, represented in a relative value from a given value, or represented by using other corresponding information. For example, radio resources may be specified by a given index.

Names used for parameters and the like in the present disclosure are in no respect limiting. Further, any mathematical expression or the like that uses these parameters may differ from those explicitly disclosed in the present disclosure. Various channels (e.g., PUCCH and PDCCH) and information elements can be identified by any suitable name. Various names allocated to these various channels and information elements are in no respect limiting.

The information, signals, and the like described in the present disclosure may be represented by using any of various different pieces of technology. For example, data, instructions, commands, information, signals, bits, symbols, chips, and the like, which may be referenced throughout the above description, may be represented by voltages, currents, electromagnetic waves, magnetic fields, magnetic particles, optical fields, optical photons, or any combination thereof.

Information, signals, and the like can be output at least one of from higher layer to lower layer and from lower layer to higher layer. Information, signals, and the like may be input/output via a plurality of network nodes.

The input/output information, signals, and the like may be stored in a specific location (e.g., memory), or may be managed in a control table. The information, signals, and the like to be input and output can be overwritten, updated, or appended. The output information, signals, and the like may be deleted. The input information, signals, and the like may be transmitted to another apparatus.

Information is not required to be reported by a method of an aspect/embodiment described in the present disclosure, and may be reported by another method. For example, in the present disclosure, information may be reported by physical layer signaling (e.g., downlink control information (DCI) and uplink control information (UCI)), higher layer signaling (e.g., radio resource control (RRC) signaling, broadcast information (master information block (MIB), and system information block (SIB)), and medium access control (MAC) signaling), another signal, or a combination thereof.

Note that the physical layer signaling may be referred to as layer 1/layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. The MAC signaling may be reported by using, for example, a MAC control element (CE).

Given information (e.g., “being X”) may be reported not explicitly but implicitly (e.g., by not reporting the given information or by reporting other information).

Decision may be made in a value represented by one bit (0 or 1), in a Boolean value represented by true or false, or by comparing numerical values (e.g., comparison against given value).

Regardless of whether referred to as software, firmware, middleware, microcode, or hardware description language, or referred to by other names, software should be broadly interpreted so as to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, instruction, information, and the like may be transmitted/received via a transmission medium. For example, when software is transmitted from a website, a server, or other remote sources by using at least one of wired technology (coaxial cable, optical fiber cable, twisted-pair cable, digital subscriber line (DSL), and the like) or wireless technology (infrared light, microwave, and the like), at least one of these wired technology and wireless technology is included in the definition of the transmission medium.

The terms “system” and “network” used in the present disclosure may be compatibly used. The “network” may mean an apparatus (e.g., base station) included in the network.

In the present disclosure, terms such as “precoding”, “precoder”, “weight (precoding weight)”, “quasi-Co-Location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be compatibly used.

In the present disclosure, the terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, “component carrier”, and the like may be compatibly used. The base station may be referred to by a term such as a macro cell, a small cell, a femto cell, a pico cell, and the like.

A base station can accommodate one or a plurality of (e.g., three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or all of the coverage area of at least one of a base station and a base station subsystem which provide communication service in the coverage.

In the present disclosure, the terms such as a “mobile station (MS)”, a “user terminal”, “user equipment (UE)”, and a “terminal” can be compatibly used.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

At least one of the base station or the mobile station may be referred to as a transmitting apparatus, a receiving apparatus, a radio communication apparatus, and the like. Note that at least one of the base station and the mobile station may be a device mounted on a moving body, a moving body itself, and the like. The moving body may be a transportation (for example, a car, an airplane, or the like), an unmanned moving body (for example, a drone, an autonomous car, or the like), or a (manned or unmanned) robot. Note that at least one of the base station and the mobile station also includes an apparatus that does not necessarily move during a communication operation. For example, at least one of the base station and the mobile station may be Internet of Things (IoT) device such as a sensor.

The base station in the present disclosure may be replaced with a user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be replaced with terms corresponding to communication between terminals (for example, “side”). For example, an uplink channel and a downlink channel may be replaced with a side channel.

Similarly, the user terminal in the present disclosure may be replaced with a base station. In the case, the base stations 10 may have a function of the above-described user terminal 20.

In the present disclosure, an operation performed by a base station may be performed by an upper node thereof in some cases. In a network including one or a plurality of network nodes with a base station, it is clear that various operations performed so as to communicate with a terminal can be performed by a base station, one or a plurality of network nodes (e.g., mobility management entity (MME) and serving-gateway (S-GW) may be possible, but are not limiting) other than the base station, or a combination thereof.

The aspects/embodiments illustrated in the present disclosure may be used independently or in combination, and may be switched along with execution. Further, the order of processing procedures, sequences, flowcharts, and the like of the aspects/embodiments described in the present disclosure may be re-ordered as long as there is no inconsistency. For example, in the methods described in the present disclosure, various step elements are presented by using an illustrative order, and the methods are not limited to the presented specific order.

Each aspect/embodiment described in the present disclosure may be applied to a system using long term evolution (LTE), LIE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded on the basis of these, and the like. Further, a plurality of systems may be combined and applied (for example, a combination of LTE or LTE-A and 5G, and the like).

The phrase “based on” used in the present disclosure does not mean “based only on”, unless otherwise specified. In other words, the phrase “based on” means both “based only on” and “based at least on”.

Reference to any element using designations such as “first”, “second”, and the like used in the present disclosure does not generally limit the quantity or order of these elements. These designations can be used in the present disclosure, as a convenient way of distinguishing between two or more elements. Reference to the first and second elements does not mean that only two elements may be adopted, or that the first element must precede the second element in some way.

The terms “judging (determining)” used in the present disclosure may encompass a wide variety of operations. For example, “judging (determining)” may be regarded as “judging (determining)” judging, calculating, computing, processing, deriving, investigating, looking up, search, inquiry (e.g., looking up in table, database, or another data structure), ascertaining, and the like.

“Judging (determining)” may be regarded as “judging (determining)” receiving (e.g., receiving information), transmitting (e.g., transmitting information), input, output, accessing (e.g., accessing data in memory), and the like.

“Judging (determining)” may be regarded as “judging (determining)” resolving, selecting, choosing, establishing, comparing, and the like. That is, “judging (determining)” may be regarded as “judging (determining)” some operations.

“Judging (determining)” may be replaced with “assuming”, “expecting”, “considering”, and the like.

As used in the present disclosure, the terms “connected” and “coupled”, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

As used in the present disclosure, when two elements are connected, these elements may be considered “connected” or “coupled” to each other by using one or more electrical wires, cables, printed electrical connections, and the like, and, as a number of non-limiting and non-inclusive examples, by using electromagnetic energy having wavelengths in the radio frequency, microwave, and optical (both visible and invisible) regions, or the like.

In the present disclosure, the phrase “A and B are different” may mean “A and B are different from each other”. Note that the phrase may mean that “A and B are different from C”. The terms such as “separated”, “coupled”, and the like may be similarly interpreted as “different”.

When the terms such as “include”, “including”, and variations of these are used in the present disclosure, these terms are intended to be inclusive, in a manner similar to the way the term “comprising” is used. Furthermore, the term “or” as used in the present disclosure is intended to be not an exclusive-OR.

In the present disclosure, when articles, such as “a”, “an”, and “the” are added in English translation, the present disclosure may include the plural forms of nouns that follow these articles.

Now, although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined on the basis of the description of claims. Consequently, the description of the present disclosure is provided only for the purpose of explaining examples, and should by no means be construed to limit the invention according to the present disclosure in any way.

1. A terminal comprising:
a receiving section that receives information regarding a repetition factor and information regarding a redundancy version sequence used for a repetition transmission; and
a control section that determines, when the repetition factor is greater than eight, a transmission occasion at which initial transmission of a transport block can be started from a plurality of transmission occasions corresponding to the repetition factor based on at least one of the redundancy version sequence and the repetition factor.

2. The terminal according to claim 1, wherein when the repetition factor is greater than eight, in all configurable redundancy versions, the control section determines a transmission occasion at which the initial transmission can be started according to the same condition as in a case where the repetition factor is eight.

3. The terminal according to claim 1, wherein when the repetition factor is greater than eight, in a specific redundancy version sequence, the control section determines a transmission occasion at which the initial transmission can be started according to a condition different from the condition as in a case where the repetition factor is eight.

4. The terminal according to claim 3, wherein when a plurality of repetition factors having a value of eight or more is supported, the number of transmission occasions for which the initial transmission cannot be started in a plurality of transmission occasions corresponding to the respective repetition factors is separately configured.

5. A radio communication method comprising:
a step of receiving information regarding a repetition factor and information regarding a redundancy version sequence used for a repetition transmission; and
a step of determining, when the repetition factor is greater than eight, a transmission occasion at which initial transmission of a transport block can be started from a plurality of transmission occasions corresponding to the repetition factor based on the redundancy version sequence and the repetition factor.

6. A base station comprising:
a transmitting section that transmits information regarding a repetition factor and information regarding a redundancy version sequence used for a repetition transmission; and
a control section that controls, when the repetition factor is greater than eight, reception of a transport block whose initial transmission is started in a transmission occasion selected based on the redundancy version sequence and the repetition factor.
